(19) United States
(12) Patent Application Publication
(10) Pub. No.: US 2005/0180009 A1
(43) Pub. Date: Aug. 18, 2005

(54) Anti-reflection sheet

(76) Inventors: Kun-Lin Chuang, Ping Chen City (TW); Shu-Yuan Huang, Ping Chen City (TW); Ming-Hsiung Sung, Ping Chen City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/935,453

(22) Filed: Sep. 7, 2004

(30) Foreign Application Priority Data
Feb. 12, 2004 (TW) 93103384

(51) Int. Cl. G02F 1/1333; G02B 5/30; G02B 27/28

(52) U.S. Cl. 359/493; 359/492

(57) ABSTRACT

An anti-reflection sheet has an optical sheet and a resin layer. A surface of the resin layer has a plurality of nano-particles, and spacings between the nano-particles are less than 400 nanometers. The nano-particles are dispersed into a resin substrate, and then the resin substrate is coated on the optical sheet by wet coating. After that, the optical sheet is baked to remove a solvent thereof, and some nano-particles are thus distributed on the surface of the resin layer with spacings therebetween of less than 400 nanometers.

### BACKGROUND

1. Field of Invention

The present invention relates to an anti-reflection sheet. More particularly, the present invention relates to an anti-reflection sheet of which the surface has nano-particles.

2. Description of Related Art

Recently, the market is mainly occupied by liquid crystal displays (LCDs) due to the high display quality and the low power consumption of the LCDs. High brightness, high resolution, wide viewing angle and high contrast have become the critical demands of the LCDs. However, one reason for bad contrast of the LCD is the reflection of external light caused by the panel of the LCD. When light passes through an interface between two different media, such as the interface between air and an LCD panel, the light is reflected, and the reflected light increases the brightness while the LCD is in a dark state, thus decreasing its contrast.

In the conventional optical techniques, coating techniques are widely used to reduce the reflection caused by an optical element. Quarter wavelength film, which can even comprise a single layer, is the simplest and cheapest anti-reflection coating technique. The quarter wavelength mentioned here refers to the wavelength of light, and the relationship of it to the thickness of a film can be illustrated as

$${n}_{2} t = \frac{λ}{4} \qquad ( 1 )$$

When light shines on an optical sheet coated with a quarter wavelength film corresponding to the incident light, the reflectivity R thereof is shown in the following equation (2) as

$$R ( \% ) = 100 \cdot \frac{( {n}_{2}^{2} - {n}_{0} n )}{( {n}_{2}^{2} + {n}_{0} n )} \qquad ( 2 )$$

In the equations (1) and (2), n₀ is the refractive index of air, n₂ is the refractive index of the quarter wavelength film, n is the refractive index of the optical sheet, t is the thickness of the quarter wavelength film, and λ is the wavelength of the incident light.

Hence, in order to effectively reduce the reflection and enhance the contrast, the conventional LCD usually is coated with a quarter wavelength film on its polarizer to achieve the purpose. The refractive index of the polarizer is about 1.5, and the reflectivity of the polarizer without the quarter wavelength film is about 4% to 4.5%. The material used for coating on the polarizer in the prior art is a material such as a resin of which the refractive index is 1.4, and the reflectivity of the polarizer having the quarter wavelength film made of resin is about 2% to 2.5%.

In other words, after being coated with a quarter wavelength resin film, the reflectivity of the LCD is only reduced by about 2%, and that still is not enough to satisfy the strict requirements of modern LCDs. If one wants to further reduce the reflectivity of the LCD, a material of a lower refractive index has to be coated on the polarizer, but low refractive index materials are few and expensive, which substantially increases the manufacturing cost.

The anti-reflection technique described above, which coats resin on the polarizer, is called a wet anti-reflection technique. Besides the wet anti-reflection technique, a dry anti-reflection technique is also provided in the prior art, in which a multi-layer film is coated on the polarizer by sputtering to reduce the reflectivity of the LCD. However, manufacturing devices used in the dry anti-reflection technique are very expensive and entail highly skilled use, and polarizer manufacturers have to additionally buy these manufacturing devices which are not generally used in common processes, thus increasing the expenditure of manufacturing.

Moreover, LCDs are widely used in small portable televisions, mobile telephones, video recording units, notebook computers, desktop monitors, projector televisions and so on, and have gradually replaced the conventional cathode ray tube (CRT) as a mainstream display unit. But, the aforementioned dry anti-reflection technique, which coats a multi-layer film by sputtering, is not suitable for being used in large-sized LCDs because of its congenital process limitations.

### SUMMARY

It is therefore an objective of the present invention to provide an anti-reflection sheet, in which an anti-reflection layer is directly coated on an optical sheet, to effectively reduce the reflectivity of the original optical sheet and thereby enhance the contrast of the LCD and to decrease difficulty and complexity of manufacturing processes.

It is another objective of the present invention to provide a method for manufacturing an anti-reflection sheet, on the premise that the manufacturing cost is not substantially increased, to reduce the reflectivity of an optical sheet and be suitable for manufacturing a large-sized optical sheet, such as the polarizer of a large-sized LCD.

In accordance with the foregoing and other objectives of the present invention, an anti-reflection sheet is provided. The anti-reflection has an optical sheet and a resin layer. A surface of the resin layer has a plurality of nano-particles, and spacings between the nano-particles are less than 400 nanometers. The nano-particles are dispersed into a resin substrate, and then the resin substrate is coated on the optical sheet by wet coating. After that, the optical sheet is baked to remove a solvent thereof, and some nano-particles are thus distributed on the surface of the resin layer with spacings therebetween of less than 400 nanometers.

This distribution of the nano-particles formed on the surface of the resin layer, in which a spacing of the nano-particles is less than 400 nanometers, substantially lowers the refractive index of the resin layer. The invention thereby reduces the high reflectivity of the conventional single-layer anti-reflection film and effectively decreases the manufacturing cost without coating a multi-layer film by sputtering as before.

According to one preferred embodiment of the invention, the optical sheet is a polarizer. The polarizer comprises a substrate, and a material of the substrate is selected from the group consisting of polyethylene (PE), polyethylene terephthalate (PET), and triacetylcellulose (TAC). The resin layer is coated directly on the substrate, or is coated on a hard-coating (HC) layer or an anti-glare (AG) layer located on the substrate.

The material of the nano-particles is silicon dioxide or silicon dioxide doped with fluorine, and the size of the nano-particles is less than 400 nanometers and preferably between 50 and 100 nanometers. The material of the resin layer comprises acrylic resin, and a solvent of the resin material is isopropyl alcohol (IPA). The manufacturing method further uses UV light to expose and solidify the resin layer to fix positions of the nano-particles.

In conclusion, the invention forms a distribution of nano-particles, in which a spacing of the nano-particles is less than 400 nanometers, and uses the optical properties of the distribution to substantially lower the refractive index of the resin layer and therefore reduces the reflectivity of the anti-reflection sheet. The structure of the anti-reflection sheet is simple and easily manufactured and therefore can be used to replace the conventional anti-reflection techniques, which reduce the reflectivity by expensive low refractive index materials or high cost sputtered multi-layer films. Moreover, the invention reduces the manufacturing cost and is suitable for manufacturing large-sized optical sheets.

It is to be understood that both the foregoing general description and the following detailed description are examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 illustrates a schematic view of an anti-reflection sheet of one preferred embodiment of the invention

FIG. 2A illustrates a schematic view of an anti-reflection sheet of another embodiment of the invention;

FIG. 2B illustrates a schematic view of an anti-reflection sheet of another embodiment of the invention;

FIG. 2C illustrates a schematic view of an anti-reflection sheet of another embodiment of the invention;

FIG. 3A illustrates a flow chart of the manufacturing method of one preferred embodiment of the invention; and

FIG. 3B illustrates a schematic view of the preferred embodiment of the invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The invention is related to the anti-reflection of an optical sheet, such as the coating on the surface of a polarizer in an LCD. Nano-particles are added in a resin layer to increase the difference between the refractive indices of the resin layer and the optical sheet, to reduce the reflectivity of the optical sheet. Thus, the invention enhances the contrast of the LCD, and also increases the visibility of the LCD.

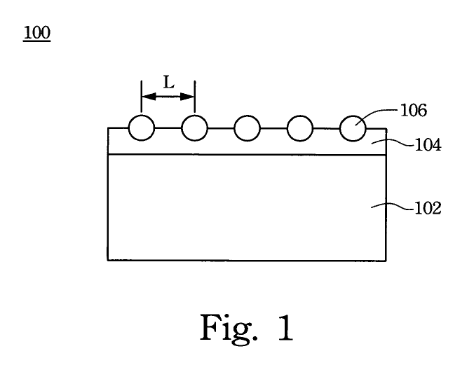

FIG. 1 illustrates a schematic view of an anti-reflection sheet of one preferred embodiment of the invention. As illustrated in FIG. 1, an anti-reflection sheet 100 has an optical sheet 102 and a resin layer 104. The resin layer 104 is located on the optical sheet 102, and the surface of the resin layer 104 has a plurality of nano-particles 106. Spacings L formed between the nano-particles 106 are less than 400 nanometers. This distribution of the nano-particles 106 lowers the original refractive index of the resin layer 104 and, by optical interference, reduces the reflectivity of the anti-reflection sheet 100.

In this preferred embodiment, the material of the resin layer comprises acrylic resin, of which the refractive index is 1.48. The material of the nano-particles is silicon dioxide or silicon dioxide doped with fluorine, wherein the fluorine doping is done to further lower the refractive index of the silicon dioxide. Moreover, the size of the nano-particles is less than 400 nanometers, thus facilitating the formation of a distribution of nano-particles 106 with spacings L less than 400 nanometers.

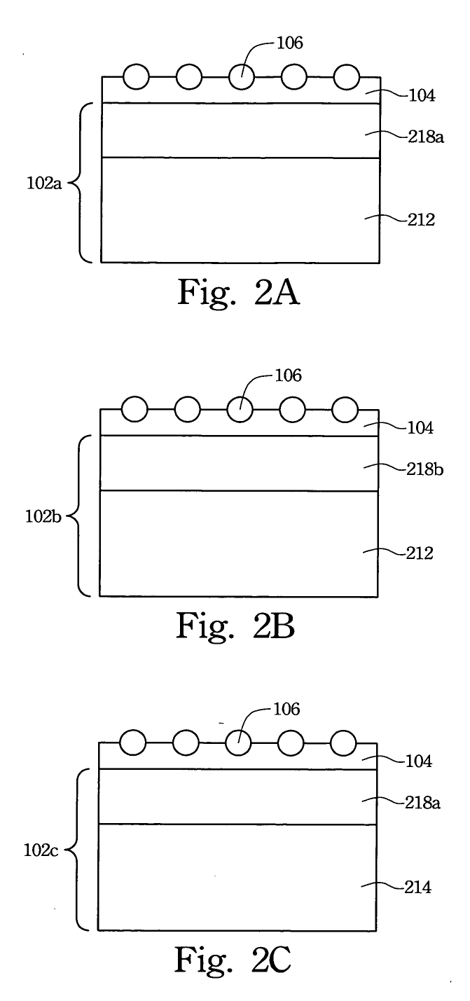

Furthermore, the optical sheet 102 is a polarizer. The polarizer comprises a substrate, and a material of the substrate is selected from the group consisting of polyethylene (PE), polyethylene terephthalate (PET), and triacetylcellulose (TAC). The resin layer 104 is coated directly on the substrate, or is coated on a hard-coating (HC) layer or an anti-glare (AG) layer located on the substrate, as illustrated in FIGS. 2A to 2C, respectively. FIGS. 2A to 2C illustrate schematic views of anti-reflection sheets of the other three embodiments of the invention, to interpret the relations between the substrate and the resin layer.

As illustrated in FIG. 2A, an optical sheet 102a uses a triacetylcellulose (TAC) layer 212 to be a substrate, and a hard-coating layer 218a is located on the triacetylcellulose layer 212. The material of the hard-coating layer 218a is acrylic resin, of which the hardness is higher than that of the substrate and therefore can prevent wear and improve the anti-friction capability of the optical sheet 102a.

As illustrated in FIG. 2B, besides the hard-coating layer 218a in FIG. 2A, an anti-glare layer 218b can be located on a triacetylcellulose (TAC) layer 212 of another optical sheet 102b. The material of the anti-glare layer 218b comprises acrylic resin and silicon dioxide particles, of which the function is just to scatter light to reduce the glare. However, the anti-glare layer 218b is different from the anti-reflection layer of the invention. In brief, the light scattered by the anti-glare layer 218b is not eliminated, but the anti-reflection layer of the invention cancels light by optical interference, and therefore, the two layers are totally different.

As illustrated in FIG. 2C, besides the triacetylcellulose (TAC) layer 212, the substrate of the optical sheet 102c can be a plastic substrate, such as a polyethylene (PE) layer 214 or a polyethylene terephthalate (PET) layer. In order words, the invention can be used on every plastic substrate, in line with the progression of the usage of plastic optical elements, to provide a cheap and effective anti-reflection wet coating layer.

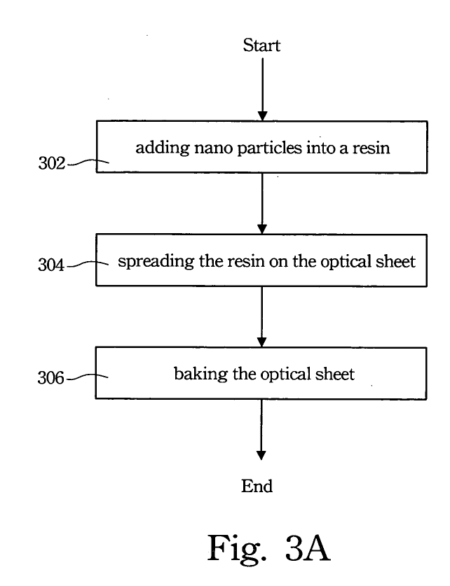

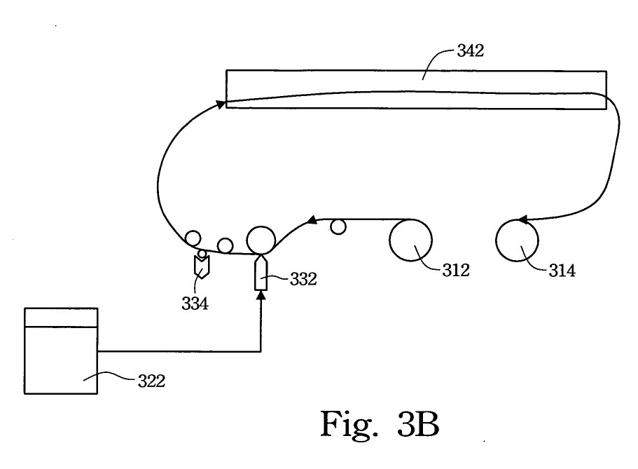

FIG. 3A illustrates a flow chart of the manufacturing method of one preferred embodiment of the invention, and FIG. 3B illustrates a schematic view of the preferred embodiment of the invention, to interpret the manufacturing devices used in the manufacturing flow in FIG. 3A. The following descriptions refer to FIG. 1, FIG. 3A and FIG. 3B.

In this preferred embodiment, rollers 312 and 314 are in charge of conveying the anti-reflection sheet 100. Firstly, nano-particles ranging in size from 50 to 100 nanometers are mixed into the acrylic resin in a mixing chamber 322 (step 302). The solvent added in the acrylic resin is isopropyl alcohol, and the nano-particles are silicon dioxide. The relationship of the weight percents of the silicon dioxide nano-particles to the acrylic resin and to the isopropyl alcohol is about 30%: 40%: 30%.

The acrylic resin having nano-particles is placed on the surface of the polarizer by a filling head 332 and then is spread uniformly on the polarizer by a wire bar 334 (step 304). The preferred spreading thickness is about 100 nanometers and thus forms the resin layer 104. Next, the optical sheet 102 having the resin layer 104 is sent into a baker 342 to be baked at 100° C. for 10 minutes in order to remove the solvent in the resin layer 104 (step 306). After baking, the resin layer 104 is exposed to UV light for several seconds in order to be solidified and to thus fix the nano-particles 106.

Hence, by this simple coating method, the resin layer having a distribution of nano-particles with a spacing less than 400 nanometers is obtained, which has a good anti-reflection capability. From the experimental results, the reflectivity of the anti-reflection sheet 100 of the preferred embodiment can be reduced to between about 2% to 0.5%.

The spirit of the invention is to form a distribution of nano-particles on the resin layer with the spacing less than 400 nanometers. The optical properties of this distribution of the nano-particles lowers the refractive index of the resin layer and thus reduces the reflectivity of the anti-reflection sheet. This is very different from those techniques used in the prior art, which reduce the sum of the reflectivity merely by material properties, such as those provided by expensive low refractive index materials or high cost sputtered multi-layer films, not by the optical properties employed by the present invention. Moreover, the prior art only changes the ratio or the refractive indices of the two different materials to adjust the sum of the reflectivity of them. Therefore, the invention, which has a distribution of nano-particles with a spacing less than 400 nanometers, is totally different from those of the prior art because the refractive index of the resin layer is reduced by using optical properties.

In addition, the invention can be used in every optical element that needs an anti-reflection layer, and is not limited to the polarizer as described in the embodiment. The material of the nano-particles is also not only limited to silicon dioxide; other materials which are able to form a distribution of a spacing less than 400 nanometers can also be used. Besides the foregoing spreading method that uses the filling head and the wire-bar, other conventional spreading ways can also be used in the invention.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A anti-reflection sheet, comprising:
an optical sheet;
a resin layer, located on the optical sheet; and
a plurality of nano-particles, distributed on a surface of the resin layer, wherein a spacing of the nano-particles is less than about 400 nanometers.

2. The anti-reflection sheet of claim 1, wherein the optical sheet is a polarizer.

3. The anti-reflection sheet of claim 1, wherein the optical sheet comprises a substrate, and a material of the substrate is selected from the group consisting of polyethylene, polyethylene terephthalate, and triacetylcellulose.

4. The anti-reflection sheet of claim 3, wherein the optical sheet comprises a hard-coating layer positioned between the substrate and the resin layer.

5. The anti-reflection sheet of claim 3, wherein the optical sheet comprises an anti-glare layer positioned between the substrate and the resin layer.

6. The anti-reflection sheet of claim 1, wherein a size of the nano-particles is less than 400 nanometers, and a preferred range of the size of the nano-particles is 50 to 100 nanometers.

7. The anti-reflection sheet of claim 1, wherein the nano-particles comprise silicon dioxide.

8. The anti-reflection sheet of claim 1, wherein the resin layer comprises acrylic resin.

9. A method for manufacturing an anti-reflection sheet, comprising:
providing a resin material, wherein the resin material comprises a plurality of nano-particles, and a size of the nano-particles is less than 400 nanometers;
coating the resin material to form a resin layer on an optical sheet; and
baking the optical sheet to make the nano-particles distributed on a surface of the resin layer with a spacing of less than 400 nanometers.

10. The method of claim 9, wherein the optical sheet is a polarizer.

11. The method of claim 9, wherein the optical sheet comprises a substrate, and a material of the substrate is selected from the group consisting of polyethylene, polyethylene terephthalate, and triacetylcellulose.

12. The method of claim 11, wherein the optical sheet comprises a hard-coating layer positioned between the substrate and the resin layer.

13. The method of claim 11, wherein the optical sheet comprises an anti-glare layer positioned between the substrate and the resin layer.

14. The method of claim 9, wherein the nano-particles comprise silicon dioxide.

15. The method of claim 9, wherein the resin material comprises acrylic resin.

16. The method of claim 9, wherein a solvent of the resin material is isopropyl alcohol.

17. The method of claim 9, wherein the method further comprises:
solidifying the resin layer to fix positions of the nano-particles.

18. The method of claim 17, wherein the resin layer is solidified by UV light.

19. The method of claim 9, wherein a preferred range of the size of the nano-particles is 50 to 100 nanometers.
